(19) United States
(12) Patent Application Publication
(10) Pub. No.: US 2015/0304103 A1
(43) Pub. Date: Oct. 22, 2015

(54) METHOD OF GENERATING UNIQUE AND HARDLY PREDICTABLE NUMBERS OF COUPONS

(71) Applicant: DINECT SARL, Luxembourg (LU)

(72) Inventors: Konstantin REBIKOV, Kemerovo (RU); Andrey MIKHAYLISHIN, Kemerovo (RU); Sergey ZHDANOV, Kemerovo (RU)

(21) Appl. No.: 14/691,755

(22) Filed: Apr. 21, 2015

Related U.S. Application Data
(60) Provisional application No. 61/982,385, filed on Apr. 22, 2014.

(51) Int. Cl. H04L 9/08

(52) U.S. Cl. CPC H04L 9/088; H04L 9/0869

(57) ABSTRACT

The invention is related to generation of an unpredictable subsequent coupon number. The numbers are distributed evenly, and a complete usage of all digits that are allocated for the coupon number is guaranteed. The storage of all previously generated numbers is not required; only a coupon index number is required to obtain the next coupon number. The encryption scheme uses two step of the encryption keys implementation.

### CROSS-REFERENCE TO PRIOR FILED APPLICATIONS

This application claims priority to earlier filed U.S. provisional application No. 61/982,385 filed Apr. 22, 2014, which is incorporated herein in its entirety.

### FIELD OF INVENTION

The invention solves the problem of generating coupon numbers having properties of low predictability and uniqueness, without necessity of checking the entire set of numbers for their uniqueness.

### BACKGROUND

Consumers may use a coupon to purchase products with a merchant. For example, a consumer may present a paper coupon to a cashier at a point of sale (POS) terminal at a merchant store in order to get a discount on a purchase. The cashier may charge the consumer an amount equivalent to the original price of the product minus a discount amount specified by the coupon. The merchant store may recover the discounted amount from a coupon provider.

The coupons are provided with unique numbers generated by algorithms to ensure a proper use of coupons without any fraudulent activity.

Generally accepted algorithms for generating unique numbers of coupons are based on two methods:

Sequential issuing of serial numbers. This approach is very simple and does not require checking the uniqueness of the whole set, as sequential increase by one unit is guaranteed here. However, it allows one to guess a previous or next number in case one knows one or more coupons numbers, which leads to fraud risks.

Generation of random or pseudo-random numbers. This approach makes the process of guessing neighboring numbers the most difficult one, but, at the same time, it requires the performance of a complete check of the uniqueness of all previously generated numbers when generating each following number. It reduces productivity and requires the storage of all previous numbers.

The use of random or pseudo-random numbers is closely related to he so-called “random number generators” or “pseudo-random number generators”.

There are different opinions in the state of the art, within the mathematical and cryptographic communities, as to what constitutes a “random number generator.” At times, the term is used somewhat loosely, and sometimes it is used to refer to what is also commonly referred to as a “pseudo random number generator.” In the context of the present invention, a “random number generator” shall be defined to include a pseudo-random number generator. The details of how a random number generator (or a pseudo-random number generator) works, and how they can be used to generate a series of random (or pseudo-random) numbers, are well known in the art of cryptography and will not be repeated here. (A general description of random number generators and various pseudo-random number generators, and a discussion of common implementation mistakes that are made when using pseudo-random generators, is set forth in ICSA Guide to Cryptography (McGraw-Hill 1999), by Randall K. Nichols, at pages 356, 399-406, and 702, the disclosure of which is specifically incorporated herein by reference).

A person skilled in the art could choose one of many different “random number generators” known in the art for use in connection with the present invention, and any number of such devices will suffice, although it is probably most desirable, from a security standpoint, to use a cryptographic pseudo-random number generator.

Generating random numbers and pseudo-random numbers is closely related to the encryption/decryption process comprising the use of symmetric keys.

Symmetric, secret key, block encryption/decryption methods (symmetric-key) can be defined as a class of algorithms for cryptography that use identical cryptographic keys for both encryption of plaintext and decryption of ciphertext. The key determines the precise transformation. By using keys, it is possible to encrypt many different messages using one particular cryptographic algorithm with a different outcome for each key. Some cryptographic algorithms that operate on fixed word lengths are referred to as block ciphers.

Symmetric ciphers have historically been susceptible to known-plaintext attacks, chosen plaintext attacks, differential cryptanalysis and linear cryptanalysts. A careful construction of the functions for each round can greatly reduce the chances of a successful attack.

### DESCRIPTION OF RELATED ART

In the state of the art various electronic coupon issuance and redemption apparatuses, methods and systems, systems and methods for securing data, encryption keys and various features related to their utilization are disclosed.

For instance, the patent document US 20130211890 A1 discloses electronic coupon issuance and redemption apparatuses, methods and systems. Said apparatuses, methods and systems (ECIR) transform user coupon purchase and redemption request inputs via ECIR components into coupon issuance, transaction, and analytics outputs. In some embodiments of this invention, the ECIR may receive an inventory request from a coupon program manager, including at least a virtual coupon issue criteria. The ECIR therein may generate one or more account identifiers, and transmit the account identifiers to the coupon program manager. The ECIR from this invention may receive, from the coupon program manager, an issue request along with the purchase information, which may include one or inure purchase identifiers corresponding to one or more buyers. Said ECIR may determine when the received purchase information satisfies the virtual coupon issue criteria, when it satisfies the criteria, the ECIR may issue one or more virtual coupons having the one or more account identifiers, and transmit the issued virtual cards to the coupon program manager.

The patent document US 20130062420 teaches systems and methods for securing data using multi-factor or keyed dispersal. In this invention a secure data parser is provided that may be integrated into any suitable system for securely storing and communicating data. Said secure data parser parses data and then splits the data into multiple portions that are stored or communicated distinctly. Encryption of the original data, the portions of data, or both may be employed for additional security. The secure data parser from this invention may be used to protect data in motion by splitting original data into portions of data, that may be communicated using multiple communications paths. A keyed information dispersal algorithm (keyed IDA) may also be used in this invention. The key for the keyed IDA may additionally be protected by an external workgroup key, resulting in a multi-factor secret sharing scheme.

The patent document US 20050149739 A1 teaches PIN verification using cipher block chaining. A PIN verification apparatus disclosed in this invention comprises a plurality of cipher blocks linked in a Cipher Block Chain (CBC) and keyed with a secret PIN Verification Key (PVK). A first input block is coupled to a first cipher block in the CBC chain and is configured to receive a plaintext block derived from a secret PIN. A second input block is coupled to a second cipher block in the CBC chain capable of receiving a plaintext block derived from a non-secret entity-identifier and ciphertext from a cipher block in the CBC chain.

The patent document US 20140074719 A1 teaches a system and a method for computerized negotiations based on coded integrity. In this invention an accelerated transparent authenticated Data Exchange system from this invention wherein the chronology of alternating senders' and receivers' messages are authenticated typically at each step is disclosed. The above system is useful for managing computerized negotiations including client-initiated computerized negotiations and including computerized financial transactions.

The patent document US 20130124292 A1 teaches a system and a method for generating a strong multi factor personalized server key front a simple user password.

This invention relates to a method of generating a multi-factor encryption key using a simple password in order to access control over information stored at a second entity from a first entity via at least one communication network. In one embodiment of this invention this is accomplished by, requesting to receive an application at the first entity from the second entity via the communication network, activating the first entity to generate a shared secret key, wherein the shared secret key is computed from a first entity specific ID and a random number generated at the first and second entity and allowing the user to register with the application of the second entity by the first entity, wherein the registration include entry of a personal PIN (personal identification number), a personal message etc.

The patent document US 20130062420 teaches a method and apparatus for encoding and decoding sequential index numbers to pseudo-random Personal Identification Codes (PINs) of varying word size. The encoding and decoding process therein utilizes a symmetric, secret key, block encryption/decryption method. The index numbers are encrypted and the output result produces the PIN numbers. The encryption process may be reversed to a decryption process using a mode control input. There is a one-to-one correspondence between a single index number and the resulting PIN number, thus forming a unique ordered pair described in this document.

The U.S. Pat. No. 8,543,812 B2 teaches efficient and secure cryptographic coupon reloading. In this invention a system and a method for cryptographic reduced-coupon reloading are provided, where a coupon includes a pseudo-random number ri=PRFK(i), where i is an index for labeling the coupon, PRE is a predetermined pseudo-random function and K is a regeneration key, and a “reduced-coupon” xi=ƒ(ri), where ƒ is a predetermined one-way function, where: a candidate device and a second device acquire a common value of a token T, the candidate device transmits a verification value vTto to the second device, the second device verifies whether the verification value is equal to PRFQ(T), where PRE′ is a predetermined keyed pseudo-random function identical to, or derived from, the pseudo-random function PRF, where Q is an authentication key owned by the second device and known to the candidate device provided the candidate device is a legitimate reloading device, and if the verification is positive, one or several reduced-coupon(s) provided by the candidate device are stored in the second device.

Thus, in the state of the art various systems and methods related to coupon handling (coupon issuance, transaction, and analytics) and verification of processes related to coupon handling are disclosed. Particularly, the systems of generating coupon numbers are disclosed. A simplification of the process of coupon number generating could greatly reduce the efforts aimed at a safe and reliable coupon issuance.

The present invention solves the problem of generating coupon numbers having properties of low predictability and uniqueness, without necessity of checking the entire set of numbers tor their uniqueness.

### SUMMARY

The invention is related generation of each subsequent coupon number that does not require a verification of its uniqueness in comparison with all the previous ones, but its uniqueness is guaranteed by the algorithm used. Furthermore, the numbers are distributed evenly, and a complete usage of all digits that are allocated for the coupon number is guaranteed. The invention is further characterized in that the storage of all previously generated numbers is not required; only a coupon index number is required to obtain the next coupon number.

The coupon number consists of 25 digits: the first 12 are the coupon prefix, the 13^{th} digit is a first checksum. The following 14-24^{th} digits are the coupon index number, which is followed by a second checksum having 25^{th} position.

The coupon prefix includes the country code (positions 1-3), the organization code (positions 4-9) and the offer number (positions 10-12).

The offer number is then encrypted to obtain the coupon index number.

First, a two component key is generated using the offer number. The two component key is divided into part 1 and part 2. Two steps of enciphering are used, which sequentially use parts of the two component key.

### BRIEF DESCRIPTION OF DRAWINGS

FIG. 1 is a block diagram from prior art showing a symmetrical encryption/decryption unit.

FIG. 2 is a simplified block diagram from prior an showing the encrypting/decrypting process as a one to one mapping.

FIG. 3 depicts a unique digital coupon identifier of the present invention consisting of the 25 decimal numbers.

FIG. 4 depicts more details of the digital coupon identifier of the present invention consisting of the 25 decimal numbers.

FIG. 5 illustrates the encryption algorithm of the present invention for generating coupon numbers.

### DETAILED DESCRIPTION OF THE INVENTION

in the following detailed description of a preferred embodiment of the invention, reference is made to the accompanying drawings that form a part hereof, and in which are shown by way of illustration a specific embodiment in which the invention may be practiced. It is understood that other embodiments may be utilized and structural changes may be made without departing from the scope of the present invention.

Symmetric, secret key, block encryption/decryption methods (symmetric-key) are defined as a class of algorithms for cryptography that use identical cryptographic keys for both encryption of plaintext and decryption of ciphertext. The keys, in practice, represent a shared secret. Other terms for symmetric-key encryption are secret-key, single-key, shared-key, one-key, and private-key encryption. Symmetric-key cryptography transforms (scrambles) a message into something resembling random noise. The key determines the precise transformation. Mathematically, a cryptographic algorithm is a function that maps a message onto a ciphertext (an encrypted message). By using keys, it is possible to encrypt many different messages using one particular cryptographic algorithm with a different outcome for each key. Some cryptographic algorithms that operate on fixed word lengths are referred to as block ciphers. Block (word) sizes of 32, 64, and 256 bits are commonly used. Some examples of popular and well-respected symmetric encryption/decryption algorithms are Twofish, Serpent, AES (Rijndael), Blowfish, CASTS, RC4, DES, Triple-DES, and IDEA.

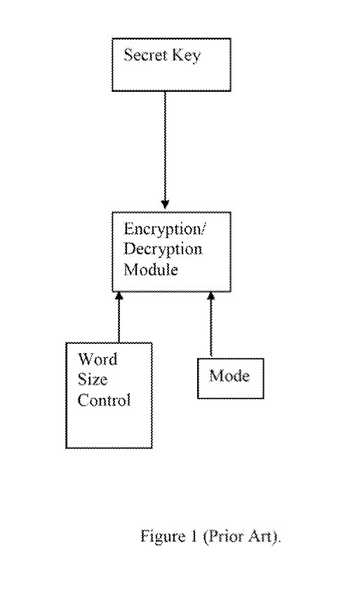

FIG. 1 shows a Symmetrical Encryption/Decryption Module from prior art. Its operation is defined by the binary mode control and places the module in either an encryption mode or a decryption mode. The Mode control defines the context of the input data or the output data.

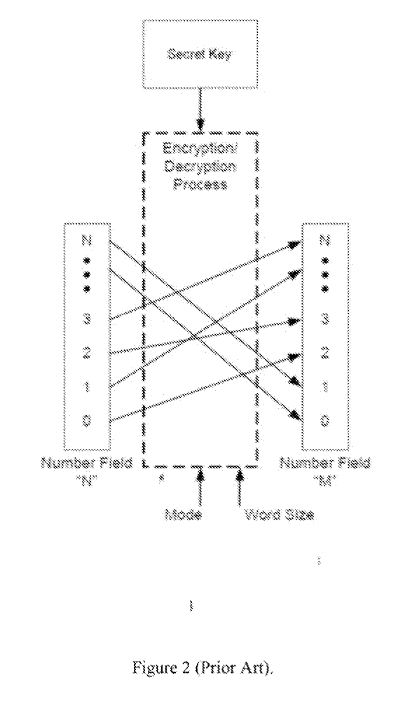

FIG. 2 depicts the concept of the Encryption/Decryption process as a “mapping” function defined by the contents of secret key from prior art. Number field “N” is a contiguous ascending group of numbers ending at “N”. Number field “M” is also a contiguous ascending group of numbers ending at “N”. Secret key defines the mapping relationship that “scrambles” or de-correlates the input numbers (Field “N”) to the output numbers (Field “M”).

FIG. 3 depicts a digital coupon identifier of the present invention consisting of the 25 decimal numbers.

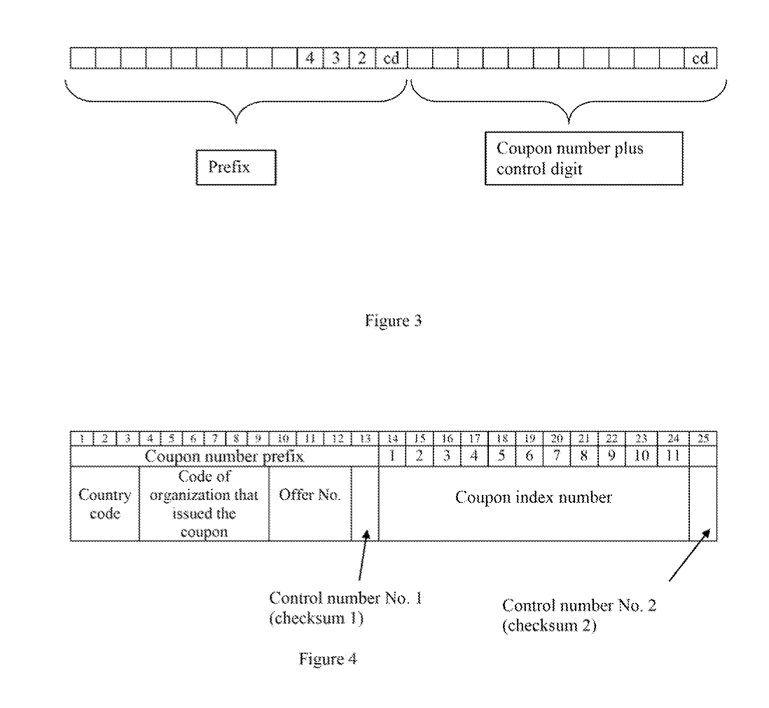

FIG. 4 depicts more details of the digital coupon identifier of the present invention consisting of the 25 decimal numbers

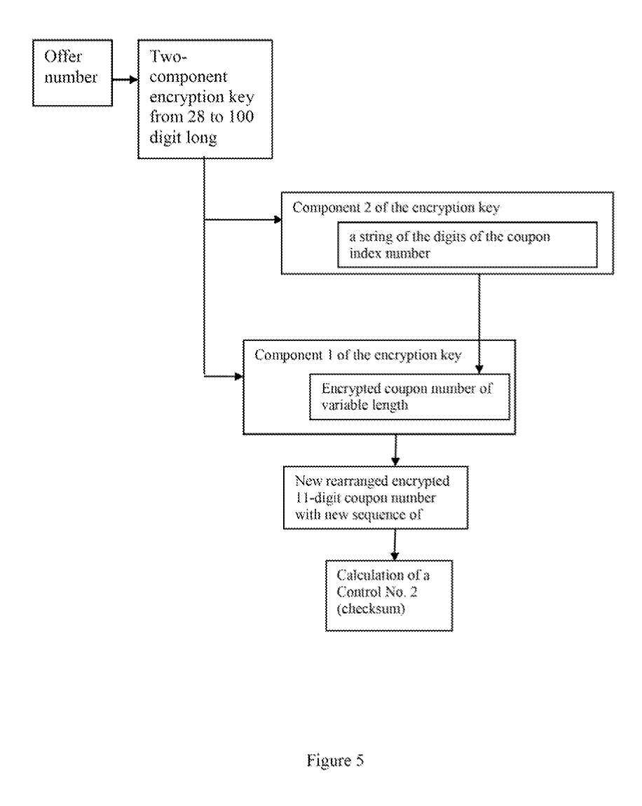

FIG. 5 illustrates the encryption algorithm of the present invention for generating coupon numbers.

The preferred embodiment of the algorithm of the present invention is as follows:

The digital coupon identifier consists of the 25 digits, where the first 13 numbers are the prefix, and they are not encrypted. The prefix consists of country code (first three digits), the code of the organization that issued this coupon (digits from 4^{th} to 9^{th} including) and the offer number (digits from 10^{th} to 12^{th}), see FIG. 4. The offer number never starts from 9.

The 13^{th} position is for a Control No. 1 (a checksum No. 1).

The following 12 numbers (positions from 14^{th} to 24^{th}) are for the coupon serial number. The last 25^{th} position is for a Control No. 2 (a checksum No. 2).

The procedure of the unique 25-digit coupon number generation starts with creating a new two-component encryption key for each offer number by random generation. This key is from 1 to 100 digits long.

The first and the second components are used in different steps of the encryption. The dividing the two component key into a part 1 and a part is performed by cutting in half. In case of odd key number, the pat 1 is one digit longer. In the preferred embodiment, the two-component key comprises a number having from 28 and 100 digit. The part 1 contains 14-50 digits, and the part 2 contains 14-50 digits.

In encrypting a string of digits of the coupon index number (11 bits) a second component 2 of the two-component key shown in FIG. 5 is utilized. The encryption is performed by trusted platform module by addition of module of 10. Encrypting is performed using a symmetric encryption algorithm. As a result an encrypted coupon number is obtained. This encrypted coupon number has a variable length. In general, any type of encryption can be used to obtain the encrypted coupon number.

A first component 1 of the two-component key shown in FIG. 5 encrypts the obtained the encrypted coupon number with a variable length. The encryption is performed by a matrix over a ring. As a result of this procedure a new rearranged encrypted 11-digit coupon number is generated. The new coupon number has a new sequence of digits, see FIG. 5. In general, any type of encryption can be used to obtain the new coupon number.

Subsequently, in accordance with the resulting string numbers, the Control No. 2 (the checksum) is calculated, and, thus, the 12th digit is obtained, in the position 25, see FIG. 4.

The following algorithms may be used for the checksums: Parity byte or parity word, Modular sum, Position-dependent checksums, “Module 10”.

The latter consists of the following steps:
Numbering digits in the set from right to left.
Calculating the sum of digits in the even and odd positions.
Adding the sum of digits in the even positions to the triple sum of digits in the odd positions.
Comparing the ones digit in the obtained result to zero. If the ones digit of the obtained result is equal to zero, then the check digit is 0. If the last digit of the result is not zero, then the check digit is equal to the number which should be added to this digit to obtain 10.

As a result of the combination of the 13-digit prefix and the 12-digit coupon number, the 25-digit unique coupon identifier is obtained.

To complement the description being made and with a view to contributing towards a better understanding of the characteristics of the invention, according to preferred example of the practical embodiment thereof, a specific practical example is provided below.

For instance, an index offer number (1, 2 or 3) is taken, and the secret component 2 of the encryption key (567,322,239 . . . ) is generated from it.

Thereafter, an index coupon number for each offer N (1-2-3,1-2-3,1-2-3 . . . ) is taken and encrypted by component 2 of the encryption key using the block cipher method.

As a result, three coupon numbers are obtained:

offer 1- coupon 1=567324

offer 2- coupon 1=322400

offer 3- coupon 1=239029

The combination of blocks of the second component of the encryption keys and blocks of the encryption results allows one to generate a coupon code of 6 digits (3+3).

Thereafter, 6-digit codes are combined to generate 12 digit coupon numbers encrypted). As a result, a 25 digit coupon code consisting of a 13 digit unique prefix and the 12 digit coupon number is obtained.

The coupon numbers obtained are unique, and checking these numbers is not required, because original coupon index numbers are unique, and, in addition, they are encrypted by the symmetric block cipher. Thus, a possibility of the presence of two identical encrypted coupon numbers for two different coupon index numbers after encrypting is excluded. This is achieved by the use of the symmetric encryption algorithm.

Optionally, the system further includes a database for storing the coupon numbers that were already issued.

In one embodiment, the proposed method uses electronic data transfer means (such as interact communications) for sending the generated coupon number to the clients upon request.

To prove the uniqueness of coupon numbers experimentally, a practical testing of coupon numbers was performed. In order to do this, a stand was utilized, which is a computer with a Dinect system database having at least one user and one offer installed in it. The identifiers (keys of record in the database) of user and offer were required to perform the test. To test a component “Coupon numerator ” for repetitions, it was decided to create coupons in one series of numbers (i.e, for the same offer). For this purpose, a control command Django [https: // www.djangoproject.com/] under the name “Coupon generator” was created.

The test was performed by running above command with parameters consistent with the purpose of the test, and verifying the results of the command execution. In case of generating a coupon with the number already found in the database, the command is abnormally completed with a return code of 1, and it prints an error message. If no coupon number is repeated, the command is successfully completed with a return code of 0. The component “Coupon numerator” of a subsystem of Dinect CCP system was tested for generating repetitive numbers of coupons. For this purpose, the database system under the name “Discount” was installed in a computer (with the host name “Vain”). A latest stable version of the system core (repository dm-schema) was installed on the stand as well.

To execute control commands, a virtual protect environment was created and configured. Subsequently, a command of generation of 100,000,000 (one hundred million) of coupons was run.

Thus, the command was completed successfully (with code 0), whereby testing found to be successful.

The testing resulted in a successful completion of the command of coupon generation throughout the testing, whereby testing found to be successful with 99.99% of results' significance.

The specific embodiments described herein are intended to further explain the best mode known for practicing the disclosure and to enable others skilled in the art to utilize the disclosure in such, or other, embodiments and with various modifications required by the particular applications or uses of the present disclosure. The specific techniques, conditions, materials, and proportions set forth to illustrate the principles and practice of the invention are exemplary only and should not be taken as limiting the scope of the invention. It is intended that the appended claims be construed to include alternative embodiments to the extent permitted by the prior art.

What is claimed is:

1. A method of generating unique and hardly predictable coupon numbers, comprising:
generating 25-digit number, wherein first 12 digits are a coupon prefix followed by 13th digit being is a first control number, followed by 11 digits of a coupon index number followed by 25th number, which is a second control number,
wherein the prefix number consists of a country code in digits 1-3, a code of an organization in digits from 4th to 9th and an offer number in digits from 10 to 12;
calculating a first control number (a first checksum) for a 13th digit position;
generating a two-component random key using the offer number;
the two-component random key comprising a number having from 28 to 100 digits; unique correspondence between the offer number and he two-component random key is achieved;
dividing the two component key into a part 1 and a part 2;
dividing is performed by cutting in half;
enciphering the coupon index number using the 2 of the two-component random key;
as a result—obtaining an encrypted coupon number;
enciphering the encrypted coupon number using the part A of the two-component random key and receiving a new rearranged coupon number having 11 digits;
the new rearranged coupon number is used for 14^{th}-24^{th} digit positions;
calculating a second control number (a second checksum) using the new rearranged coupon number and placing the second control number as 25^{th} digit.

2. The method of claim 1, wherein the country is a standard code used in telephone communication.

3. The method of claim 1, wherein the organization is the one that has the offer.

4. The method of claim 1, further comprising storing of the generated coupon number in a database.

5. The method of claim 5, further comprising sending the coupon numbers via electronic data transfer to a client.
